(19) United States
(12) Patent Application Publication
(10) Pub. No.: US 2025/0053136 A1
(43) Pub. Date: Feb. 13, 2025

(54) Hologram Coupling into a Waveguide

(71) Applicant: Envisics Ltd, Milton Keynes (GB)

(72) Inventor: Alexander Cole, Milton Keynes (GB)

(21) Appl. No.: 18/798,744

(22) Filed: Aug. 8, 2024

(30) Foreign Application Priority Data
Aug. 9, 2023 (GB) 2312190.8

(51) Int. Cl. G03H 1/26

(52) U.S. Cl. CPC G03H 1/265; G03H 2001/266; G03H 2223/16; G03H 2225/22; G03H 2250/38

(57) ABSTRACT

A holographic projection system includes a display arrangement. The display arrangement includes a display area arranged to display a first hologram of a first picture and to spatially modulate light incident thereon in accordance with the first hologram to form a holographic wavefront. The system further includes an optical system arranged to receive the holographic wavefront and form a relayed image of the first hologram. The system further includes a waveguide that includes an input port arranged to receive the holographic wavefront and a pair of surfaces arranged to waveguide the holographic wavefront therebetween. A plane of the display area is angled such that the relayed image of the first hologram is formed at a first plane, the first plane being parallel with a plane of the input port.

### CROSS-REFERENCE TO RELATED APPLICATIONS

This application claims the benefit of priority of United Kingdom Patent Application No. 2312190.8 filed Aug. 9, 2023, which is hereby incorporated herein by reference in its entirety.

### FIELD

The present disclosure relates to a holographic projection system comprising a waveguide and one or more holograms. More specifically, the present disclosure relates to an improved in-coupling of one or more holograms into the input port of a waveguide. Some embodiments relate to the combining or multiplexing (shorthand, “muxing”) of a plurality of holograms in the waveguide. In some embodiments, the holographic projection system is arranged to improve or optimise the coupling of one or more holograms from a common display or hologram plane into a waveguide. Some embodiments relate to a holographic projector, picture generating unit or head-up display.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

In general terms, there is provided a holographic projection system comprising a waveguide pupil expander comprising an input port. The waveguide pupil expander comprises a pair of surfaces arranged to waveguide light (received at the input port) therebetween. Generally, the holographic projection system is arranged such that the light received at the input port is a holographic wavefront. The holographic projection system according to the present disclosure provides improved coupling of the holographic wavefront into the waveguide. The improved coupling may be optically efficient. The improved coupling may, efficiently, enable the muxing of multiple holographic wavefronts (that are spatially separated at the input port of a waveguide and which may be associated with different (optical) channels, respectively of the system), within the waveguide. This may be achieved without any substantial loss of light.

In some aspects of the present disclosure, the holographic projection system is a multi-channel holographic projection system. For example, each channel of the holographic projection system may correspond to a different colour. As the skilled reader will appreciate, combining the light of each colour channel can provide a multi-colour holographic projection. For example, such a system may comprise a red (R), green (G) and blue (B) channel. As the skilled reader will appreciate, a full colour holographic projection may be achieved by combining such RGB channels. The holographic projection system according to the present disclosure advantageously provides a means to combine or “mux” light from different channels of the projector within the waveguide (rather than upstream of the waveguide, prior to being received at an input port of the waveguide, as is convention). In particular, the inventors have devised an arrangement in which the input port comprises a first input area for receiving a first holographic wavefront associated with a first channel and a second input area for receiving a second holographic wavefront associated with a second channel. By appropriately positioning the first and second input area, the first and second holographic wavefronts can be combined, or superimposed on one another, within the waveguide after one or more internal reflections therein. For example, the first holographic wavefront may be combined with the second holographic wavefront after one or more internal reflections of the first holographic wavefront. The inventors have recognised that the first holographic wavefront can be made to reflect (internally within the waveguide) on a portion of a surface of the waveguide that is aligned with the second input area. After this reflection, the first and second holographic wavefronts will advantageously be combined. The inventors have recognised that such combining or “muxing” within the waveguide is optically efficient and can be achieved with very few optical components. Conventionally, one or more dedicated components may be required to mux separate channels in a holographic projector. For example, a beam splitter cube could be used to combine the separate channels. The improved system according to the present disclosure removes the needs for such components.

The improved holographic projection system according to the present disclosure further enables a multi-channel holographic projection system in which a single display device is used in multiple channels, for example in which a single display device is arranged to display a first hologram for a first channel in a first display area and to display a second hologram for a second channel in a second display area. This requires fewer components (e.g. fewer display devices) than conventional arrangements in which an individual display device is provided for each colour channel, often referred to as a spatially-separated colour, “SSC”, arrangement (for example, a liquid crystal on silicon display device may be provided for each channel in such examples). While frame sequential colour arrangements, “FSC”, using a single display device are known, the arrangement of the present disclosure enables an SSC type arrangement using a single display (i.e. one in which spatially separated holograms for different colour channels are displayed in different areas of the single display, for example simultaneously). This is very unconventional. The arrangements according to present disclosure enables efficient coupling the a plurality of holograms (for example, simultaneously) into the input port of a waveguide without substantially loss of light. This can be achieved even when the plurality of holograms are displayed on the display device in an adjacent/abutting fashion. As well as using fewer components compared to conventional SSC, the inventors have recognised that another advantage of an SSC arrangement using a single display device for multiple channels is that full use is made of the display device, which otherwise may comprise “excess pixels”, as explained below.

The display system of the present disclosure defines a physical aperture (for picture-forming light such as a holographic wavefront) which may be a pupil of the holographic system. Conventionally, the display system comprises an array of pixels of a display device, such as a spatial light modulator. The array of pixels may display a hologram of a picture. The waveguide may be said to expand or replicate the pupil defined by the array of pixels and/or replicate the hologram displayed on the array of pixels. In some embodiments, pupil expansion corresponds to expansion of an eye-box of a head-up display. Through extensive simulation and experimental work, it has been found that the size of the array of pixels is critical to the holographic reconstruction process when a plurality of hologram replicas contribute to formation of the image. Specifically, it has been found that a human viewer is particularly sensitive to the physical size of the display device used to display the hologram. In real-world cases, it is found that the display device should have a minimum size relative to the pupil of the human eye (when a hologram replicator is used as described herein). In some embodiments, a dimension of the display device is greater than the average diameter of a human pupil. If the physical size of the display device is too small, it has been found that a human viewer perceives replication artefacts (that is, artefacts caused by the replication process) that degrade the viewing experience. This can drive a need for a relatively large display device and therefore a relatively large hologram (i.e. relatively high number of hologram pixels). For the avoidance of doubt, using larger pixels to form a larger device is not a viable alternative because of the negative effect this would have on the size of the holographic replay field. The best solution to the pupil size requirement is therefore to increase the number of pixels of the display device—but this adds cost, and is excessive from a holographic perspective. Specifically, the inventor identified that, above a certain threshold, increasing the number of hologram pixels does not benefit image quality. In this respect, it was found that the minimum size requirement to eliminate the artefacts associated with the replication process drives a need for an “excess” of hologram pixels. The inventor identified that this is an inefficiency that could be addressed by using the “excess” pixels to form a plurality of a holographic wavefronts associated, respectively, with a plurality of channels (in an SSC type mode), and then combining those channels in the waveguide, as described above.

In some aspects of the present disclosure, improved coupling is achieved as a result of co-planarisation of a hologram or relayed hologram with the input port. In particular, the inventors have devised various schemes based on the principle of co-planarisation in order to optimise the coupling of a holographic wavefront into a waveguide. This is achieved by tilting a display device, hologram or relayed hologram of the system in coordination with the input port of the waveguide. In some embodiments, the hologram or relayed hologram is co-planar (or at least parallel) with the input port. In embodiments in which a relayed hologram is aligned/coplanar with the input port, the holographic projection system may comprise an optical relay arranged to receive spatially modulated light from a display device displaying the hologram and form a relayed hologram (or relayed image of the hologram displayed on the display device) that is aligned/coplanar with the input port. After thorough simulation and experimentation, the inventors have found that this alignment achieves efficient in-coupling into the waveguide, and addresses any surprising adverse effects of the optical relay, when a holographic wavefront encoded with the hologram is received by the waveguide, particularly when muxing multiple (colour) channels as described above. The inventors found that when an optical relay is used, for example for zero-order extraction at an intermediate plane of the optical relay, optical efficiency could be adversely affected. They identified the importance of co-planarising the relayed hologram (i.e. image of the hologram at the input port of the waveguide) (i.e. not the original displayed hologram on the display device) and waveguide. Therefore, the inventors have recognised that tilting of the display device may be necessary to achieve co-planarisation of the relayed hologram and input port. As the skilled reader will appreciate, an optical relay may comprise a pair of lenses. In such cases, the image (or relayed hologram) will be flipped relative to the displayed hologram. This also means that, in such cases, the tilt of the display device may need to oppose a desired tilt of the image. In other words, the inventors have found that the display device may need to be counter-tilted. It may be said that counter-tilting of display device is needed for every 2n optical inversion of performed by the optical relay.

The above described co-planar arrangement of the hologram and the input port is very unconventional.

An orientation of the relayed hologram with respect to a propagation axis of the system may depend on the position/orientation of the display device on which the hologram is displayed. For example, a normal of the display device may be angled with respect to the propagation axis of the system (at the display device). The angle may be an acute angle. The angle may allow for the display device to operate in a reflective mode, in which light is received by the display device from a light source and reflected by the display device, without the reflected light being directed straight back to the light source. Thus, to achieve a co-planar arrangement of the hologram and the input port, the angle of the input port/waveguide must be constrained by the orientation of the display device. Achieving this arrangement introduces constraints into the design of the system which are not usually present.

Conventionally, the angles of the display device and the waveguide (and so the input port thereof) with respect to a propagation axis of the system is decided by particularly design considerations. For example, as described in more detail below, the angle of the display device may conventionally selected to be as small as possibly while allow for off-axis illumination thereof (in a reflective mode). The angle of the waveguide may conventionally be selected to achieve a desired replica pitch. The inventors have gone against both of these conventions in the implementation of the present invention.

In the illumination of a display device, normal incidence of illumination light on the display device is preferred. However, in a reflective mode, off-axis illumination of the display device may be chosen for practical reasons such that the reflected light (off the display device) is not directed straight back towards the light source (e.g. laser). In such cases, there is a general prejudice in the field that the illumination angle should be kept as close to (ideal) normal incidence. For example, an angle between a normal of the display device and light incident thereon may be only two or three degrees. The inventors have gone against this significant prejudice in the field to provide a much larger angle between the normal of the display device and the light incident thereon (e.g. 20 degrees or more). The inventors have recognised that such a large angle may be needed to achieve waveguiding in the waveguide (given that the waveguide is angled based on the angle of the display device). In other words, the inventor has identified that if you tilt the display device be a relatively large amount the benefits of the present invention can be enjoyed. Importantly, those benefits outweigh the disadvantages of off-axis LCOS illumination with a relatively large angle (against which there is a significant prejudice in the field). In fact, it could be said that the invention is synergistic with the off-axis illumination.

The waveguide may comprise a pair of opposing surfaces between which received light is waveguided. One of the opposing surfaces is partially transmissive-partially reflective so as to emit replicas of the received light therefrom. As the skilled reader will appreciate, changes in angle of the waveguide with respect to the propagation axis will change the pitch of the replicas. Conventionally, the specific angle of the waveguide with respective to the propagation axis is chosen to achieve a desired replica pitch. Constraining the angle or orientation of waveguide/input port thereof to be based on the angle of the hologram (and so the angle of the display device) removes the ability to select an orientation that achieves a desirable replica pitch. The inventors have gone against the prejudice in the field to provide a holographic system that comprises a relayed hologram that is co-planar (or parallel) with the input port of the waveguide. The inventors have further recognised that the thickness, instead of the orientation or angle, of the waveguide can be tuned to achieve a desired replica pitch. Herein, the thickness of the waveguide refers to a separation between the pair of surfaces of the waveguide between which light is waveguided. The skilled reader will appreciate how, geometrically, increasing or decreasing the separation between the pair of surfaces, while maintaining a constant orientation of the waveguide may increase or decrease the pitch between replicas, as light is repeatedly bounced (reflected) between the pair of surfaces. Tuning the thickness of a waveguide may be less straightforward than changing the orientation of a waveguide to achieve a desired replica pitch. For example, the latter may allow a single (for example, “off the shelf”) waveguide to achieve various replica pitches simply by changing the orientation of the waveguide. The former may require a custom waveguide (having a desired thickness achieving a desired replica pitch) to be manufactured and, if the desired pitch changes, the waveguide may need to be altered (e.g. polished to a new thickness) or swapped for another waveguide having the desired thickness. However, the inventors have found that, on balance, the inconvenience and increased complexity/cost of tuning the replica based on waveguide thickness is worth the improved coupling achieved in above described co-planar arrangement.

It may be advantageous to combine features of the aspects of the present disclosure relating to co-planarisation with aspects relating to a multi-channel holographic system. This is because it may be advantageous for the respective holographic wavefronts of the different channels to align exactly with respective input areas of the input port. If there is not exact alignment, then a first holographic wavefront (intended for a first input area) may overlap a second input area intended to receive a second holographic wavefront. This may adversely affect the viewing experience because the overlap may introduce artefacts. In some embodiments, each input area may comprise a filter (such as a bandpass filter) to allow the transmission of an intended wavelength of light while blocking other wavelengths. This may prevent the overlapping light from propagating into the waveguide, and so may prevent said artefacts but at the expense of loss of light and of cropping of the field of view of one or more of the holograms. A precise alignment of the holographic wavefronts with the respective input areas can be achieved when the hologram is formed at a first plane that is co-planar with the input port because the hologram is then exactly in focus at the input port (such that boundaries of the hologram are well defined).

In a first aspect of the disclosure there is provided a holographic projection system. The holographic projection system comprises a hologram of a picture. The hologram may be a first hologram of a first picture. The holographic projection system is arranged to spatially modulate light in accordance with the first hologram to form a holographic wavefront. The holographic wavefront may be described as a first holographic wavefront. For example, the holographic projection system may comprise a display arrangement comprising a display device such as a spatial light modulator such as a liquid crystal on silicon spatial light modulator. The display arrangement may be arranged to display one or more holograms in a display area thereof. The display arrangement may be configured to spatially modulated incident thereon in accordance with the first hologram to form the holographic wavefront.

The holographic projection system may further comprise an optical system arranged to receive the holographic wavefront and form a relayed image of the first hologram. The holographic projection system further comprises a waveguide. The waveguide comprises an input port. The input port is arranged to receive the (first) holographic wavefront. The waveguide further comprises a pair of surfaces. The pair of surfaces are arranged to waveguide the (first) holographic wavefront therebetween.

The plane of the display area is angled such that a relayed image of the first hologram is formed at a first plane. The first plane is parallel with or co-planar with a plane of the input port. The advantages of this unconventional co-planar arrangement have already been described above. In particular, the relayed first hologram being co-planar with the input port advantageously means that the light associated with the holographic wavefront is received by the input port as a substantially in-focus image of the first hologram (i.e. relayed hologram). If there was a substantially non-zero angle between a normal of the first plane and a normal of a plane of the input port, then at least some of the relayed first hologram received at the input port would appear out of focus. It may be particularly preferable for the first plane to be co-planar with the input port (rather than merely parallel with the input port), because if there was a substantially non-zero separation between the first hologram and the plane of the input port, the relayed first hologram received at the input port may appear out of focus.

In some embodiments, the holographic projection system is arranged such that the wavefront propagates along a propagation axis. A first angle may be defined between a normal of the display device of the display arrangement and a first portion of the propagation axis. The first portion of the propagation axis may at or adjacent to the display device. A second angle may be defined between a normal of the plane of the input port and a second portion of the propagation axis. The second portion of the propagation axis may be at or adjacent to the input port. In other words, both the display device and the input port may be angled with respect to their respective (first and second) portions of the propagation axis.

The holographic projection system is arranged such that an angle between a normal of the first plane and a portion of the propagation axis at the first plane is directly dependent on the first angle (of the display device). In other words, the position/orientation of the first plane depends on the corresponding position/orientation of the display device. The portion of the propagation axis at the first plane may be referred to as a third portion of the propagation axis. The second angle may be such that the input port is co-planar with the first plane. In some embodiments, the first angle may be substantially equal to the second angle. Such embodiments may include when the display arrangement displaying the first hologram is positioned at, or coplanar with, the input port. Such embodiments may also include when the first hologram is a relayed image of a corresponding hologram displayed on the display arrangement and there is substantially no magnification of the (relayed) first hologram relative to the hologram displayed on the display arrangement.

If there is substantially non-zero magnification of the (relayed) first hologram relative to the hologram displayed on the display arrangement, the first and second angles may not be equal. However, the first and second angles may still be directly dependent on one another (and may only be altered as a result of the magnification). Herein, references to “magnification” encompass positive and negative magnification. In other words, “magnification” encompasses a demagnification.

As above, in some embodiments, the holographic projection system is arranged such that the first hologram is a relayed image of a hologram displayed on the display arrangement. In some embodiments, the holographic projection system further comprises an optical relay comprising a pair of lenses (comprising a first lens and a second lens) arranged in cooperation. The optical relay may be positioned between the display device and the input port. The optical relay may be arranged to form the relayed image of the hologram. A first lens of the pair of lenses may be arranged to receive the holographic wavefront from the display device. In such embodiments, the display device may be positioned substantially at a front focal plane of the first lens. The first lens may be arranged to relay the (received) holographic wavefront to a second lens of the pair of lenses. The second lens may be arranged to form the relayed hologram. The second lens may be arranged to form the relayed hologram at a back focal plane of the second lens. A front focal plane of the second lens may be co-planar with a back focal plane of the first lens. The input port of the waveguide may be positioned substantially at the back focal plane of the second lens. The optical relay could also be described as a telescope. The optical relay may or may not act magnify the relayed first hologram (relayed image). In some embodiments, the first hologram is displayed on the spatial light modulator, such that the spatial light modulator is positioned at the input port of the waveguide.

In some embodiments, an angle between a normal of the front focal plane of the first lens and the normal of the display device is substantially equal to the first angle. In some embodiments, an angle between a normal of the back focal plane of the second lens and the normal of the input port is substantially equal to the second angle. In other words, the angle between the normal of the front focal plane and the display device may be substantially equal in magnitude to the angle between the normal of the back focal plane and the input port. As described above, however, this may only be when the optical relay has a net-zero magnification (such that the relayed hologram formed by the second lens is not magnified or demagnified relative to the hologram displayed on the display device).

In some embodiments, the holographic projection system further comprises a second hologram. The second hologram may be of a second picture. The second picture may be different to the first picture. The holographic projection system may be arranged to spatially modulate light in accordance with the second hologram to form a second holographic wavefront. The holographic projection system may be arranged such that the second hologram is also positioned at the first plane. In other words, both the first and second hologram may be positioned at the first plane and both the first and second hologram may be co-planar with the plane of the input port. Thus, the advantages described in relation to the first hologram being co-planar with the plane of the input port also apply to the second hologram being co-planar with the input port. For examples, first and second hologram may be exactly in-focus at the input port of the waveguide. This may be particularly advantageous when different areas of the input port are arranged to treat the first holographic wavefront differently to the second holographic wavefront because a footprint of the first holographic wavefront on the input port may be exactly aligned with an area of the input port intended for the first holographic wavefront and may not overlap with an area of the input port intended for the second holographic wavefront. Furthermore, in the co-planar arrangement, the footprint of the first holographic wavefront on the input port may not overlap the footprint of the second holographic wavefront on the input port.

In some embodiments, the optical system has a unity magnification. In such embodiments, the first angle may be substantially equal to the second angle.

In some embodiments, the optical system has non-unity magnification. In such embodiments, the first angle is not equal to the second angle.

In some embodiments, a plane of the display area of the display arrangement may be non-parallel with that of the first plane. In some embodiments, a tilt of the of the display area opposes that of the relayed image of the hologram.

In some embodiments, the input port of the waveguide may comprise a first input area and a second input area. The first input area may be arranged to receive the first holographic wavefront. The second input port area may be arranged to receive the second holographic wavefront.

In some embodiments, the first input area comprises (or is defined by) a first filter arranged to be substantially transmissive to light of the first holographic wavefront while being substantially non-transmissive to light of the second holographic wavefront. Thus, the first filter may prevent the second holographic wavefront from being coupled into the input port via the first input area. This may ensure that the first holographic wavefront is separate to the second holographic wavefront on entry into the waveguide via the input port. The first filter may also prevent the second holographic wavefront from being transmitted out of the waveguide via the first filter. The advantages of the co-planar arrangement of the first and second holograms may be synergistic with the use of the first filter. If the first and second holograms were not co-planar (and so were out of focus at the input port and with overlapping footprints on the input port), the first filter would block or filter a significant portion of the second hologram. This is optically inefficient. Furthermore, loss of a portion of the second holographic wavefront would result in a loss of (angular) information of the second hologram which could adversely affect the viewing experience. It may also result in the cropping of the field of view of the second hologram (relative to the first hologram), which, again could adversely affect the viewing experience. With the first filter in place, the co-planar first and second holographic wavefronts can be exactly aligned with the first and second input areas, respectively, and so aligned with the filter. The filter may then only block stray light of the second holographic wavefront, rather than a significant portion of the holographic wavefront.

In some embodiments, the first holographic wavefront may comprise (or consist of) light of a first wavelength and the second holographic wavefront may comprise (or consist of) light of a second wavelength. The first filter may be arranged to filter light based on wavelength. For example, the first filter may be a first bandpass filter. In such embodiments, the first filter is arranged to be substantially transmissive to light of the first wavelength while being substantially non-transmissive to light of the second wavelength.

In some embodiments, the second input area comprises (is defined by) a second filter arranged to be substantially transmissive to the second holographic wavefront while being substantially non-transmissive to first holographic wavefront. The second filter may be arranged to filter light based on wavelength. For example, the second filter may be a second bandpass filter. In such embodiments, the second filter is arranged to be substantially transmissive to light of the second wavelength while being substantially non-transmissive to light of the first wavelength.

In some embodiments, the first input area comprises a boundary edge and the first bandpass filter extends from that boundary edge. In some embodiments, the second input area abuts the first input area at the boundary edge. In some embodiments, the first and second input areas are adjacent one another such that an edge of the first input area abuts an edge of the second input area. In some embodiments, a width of the first input area in the direction of waveguiding of the waveguide is substantially equal to a width of the second input area in the direction of waveguiding.

In some embodiments, the waveguide is arranged such the first holographic wavefront is combined with the second holographic wavefront after one or more internal reflections of the first holographic wavefront between the pair of surfaces. As described previously, this provides an efficient way of muxing the first and second holographic wavefront without the need for additional optical components. The first and second hologram being co-planar with the plane of the input port helps achieve good muxing because the first and second holograms are in focus at the input port and so can be treated separately on coupling into the input port. Thus, only the first holographic wavefront may be transmitted into the waveguide at the first input area and only the second holographic wavefront may be transmitted into the waveguide at the second input area. Only after one or more internal reflections is substantially all the light of first holographic wavefront mixed/combined/superimposed with the light of the second holographic wavefront. This may avoid, for example, different portions of the light of the second holographic wavefront being reflected a different number of internal reflections in the waveguide. The first and second filters described above may have a similar beneficial effect.

The waveguide may arranged such that a footprint of the first holographic wavefront overlaps a footprint of the second holographic wavefront on a first surface of the pair of surfaces of the waveguide after one or more internal reflections.

One of the pair of surfaces of the waveguide may be partially transmissive-partially reflective such that said surface is arranged to emit a plurality of replicas of the first and second holographic wavefront when the first and second holographic wavefronts are received at the input port. The waveguide may be arranged such that each replica of the first holographic wavefront at least partially overlaps a corresponding replica of the second holographic wavefront. The waveguide may be arranged such that the first holographic wavefront is substantially aligned with the second input area after one or more internal reflection such that the first holographic wavefront is superimposed on the second holographic wavefront received by the second input area.

According to a second aspect, there is provided a holographic projection system. The holographic projection system comprises a display device or display arrangement configured to display a hologram of a picture and to spatially modulate light incident thereon in accordance with the hologram to form a holographic wavefront. The holographic projection system further comprises a waveguide comprising an input port arranged to receive the holographic wavefront and a pair of surfaces arranged to waveguide the holographic wavefront therebetween. The holographic projection system is arranged such that the hologram is positioned at a first plane or the holographic wavefront forms a relayed hologram at the first plane. The first plane is co-planar with a plane of the input port.

According to a third aspect, there is provided a method of holographic projection. The method comprises spatially modulating light in accordance with a first hologram to form a holographic wavefront. The method further comprises receiving the holographic wavefront at the input port of a waveguide. The wavefront comprises a pair of surface such that the received holographic wavefront is waveguided therebetween. The first hologram is positioned at a first plane, the first plane being co-planar with a plane of the input port.

According to a fourth aspect, there is provided a holographic projection system. The holographic projection system of the fourth aspect comprises a first hologram and a second hologram. The holographic projection system is arranged to spatially modulate light in accordance with the first hologram to form a first holographic wavefront and to spatially modulate light in accordance with the second hologram to form a second holographic wavefront. The holographic projection system further comprises a waveguide. The waveguide comprises an input port. The input port comprises a first input area arranged to receive the first holographic wavefront and a second input area arranged to receive the second holographic wavefront. The waveguide further comprising a pair of surfaces arranged to waveguide the first and second holographic wavefront therebetween. The waveguide is arranged such the first holographic wavefront is combined with the second holographic wavefront after one or more internal reflections of the first holographic wavefront between the pair of surfaces. As described above, combining the first and second holographic wavefront in the waveguide is advantageously a compact and efficient means for combining or muxing first and second holographic wavefront.

In some embodiments, the waveguide is arranged such that a footprint of the first holographic wavefront overlaps a footprint of the second holographic wavefront on a first surface of the pair of surfaces of the waveguide after one or more internal reflections. The overlap of the footprints of the first and second holographic wavefronts may be on a reverse side of the first surface to that which comprises the input port.

The waveguide may be arranged such that the first holographic wavefront is substantially aligned with the second input area after one or more internal reflection such that the first holographic wavefront is superimposed on the second holographic wavefront received by the second input area. The holographic projection system may further comprises a display arrangement comprising a first display area arranged to display the first hologram and a second display area arranged to display the second hologram.

The display arrangement may comprise a spatial light modulator comprising an active area. A first portion of the active area may form the first display area. A second portion of the active area forms the second display area. In other words, a single component (single display device) may display both the first and second holograms. The first and second display areas may be adjacent one another. The first and second display areas may abut one another.

In some embodiments, one of the pair of surfaces of the waveguide is partially transmissive-partially reflective. The partially transmissive-partially reflective surface may arranged to emit a plurality of replicas of the first and second holographic wavefront when the first and second holographic wavefronts are received at the input port. For example, a replica of the respective holographic wavefront may be formed each time the holographic wavefront is reflected by the partially transmissive-partially reflective surface.

The waveguide may be arranged such that each replica of the first holographic wavefront at least partially overlaps a corresponding replica of the second holographic wavefront. For example, each replica may be emitted from a respective emission zone of the partially transmissive-partially reflective surface. Each emission zone may partially overlap an adjacent emission zone. For example, at least 5% of an area of each emission zone may partially overlap an adjacent emission zone.

In some embodiments, the holographic projection system comprises a first light source. The first light source may be arranged to illuminate the first hologram displayed on the display arrangement. The first light source may be arranged to emit light of a first wavelength. So, the first light source may illuminate the first hologram with light of the first wavelength. The holographic projection system may further comprise a second light source. The second light source may be arranged to illuminate the second hologram displayed on the display arrangement. The second light source may be arranged to emit light of a second waveguide (different to the first wavelength). So, the second light source may be arranged to illuminate the second hologram with light of the second wavelength.

In some embodiments, the first input area comprises (is defined by) a first filter arranged to be substantially transmissive to light of the first holographic wavefront while being substantially non-transmissive to light of the second holographic wavefront. For example, the first filter may be substantially transmissive to light of the first wavelength while being substantially non-transmissive to light of the second wavelength. In some embodiments, the first filter may be a first bandpass filter.

In some embodiments, the first input area comprises a boundary edge and the first bandpass filter extends from that boundary edge. The second input area may abut the first input area at the boundary edge.

In some embodiments, the second input area comprises (is defined by) a second filter arranged to be substantially transmissive to light of the second holographic wavefront while being substantially non-transmissive to light of the first holographic wavefront. For example, the second filter may be substantially transmissive to light of the second wavelength while being substantially non-transmissive to light of the first wavelength. In some embodiments, the second filter may be a first bandpass filter.

In some embodiments, the second input area is substantially reflective to light of the first wavelength (at least on a second surface of the second input port opposing a first surface of the input port arranged to receive the holographic wavefront from the display device). The first and second input areas may be adjacent one another such that an edge of the first input area abuts an edge of the second input area. A width of the first input area in the direction of waveguiding of the waveguide may be substantially equal to a width of the second input area in the direction of waveguiding.

In some embodiments, the first and second hologram are positioned at a first plane and wherein the first plane is co-planar with a plane of input port.

According to a fifth aspect, there is provided a method of holographic projection. The method comprises spatially modulating light in accordance with a first hologram to form a first holographic wavefront. The method further comprise spatially modulating light in accordance with a second hologram to form a second holographic wavefront. The method further comprises receiving the first holographic wavefront at a first input area of an input port of a waveguide and the second holographic wavefront at a second input area of the input port. The waveguide comprises a pair of surfaces such that the received holographic wavefront is waveguided therebetween. The waveguide is arranged such the first holographic wavefront is combined with the second holographic wavefront after one or more internal reflections of the first holographic wavefront between the pair of surfaces.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 shows a schematic cross-sectional view of components of a holographic projection system according to the disclosure; and

FIG. 7 shows a ray-diagram of light emitted from two spatially separated points on a display device of the holographic projection system of FIG. 6.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

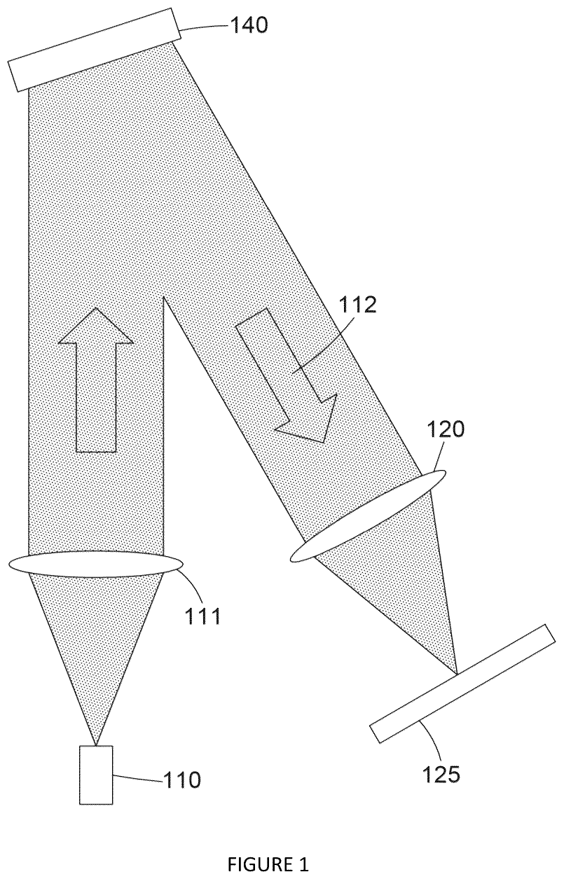

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform. In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 (published as GB2603517A) and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 (published as GB2610203A) and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 (published as GB2614286A) and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible.

A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

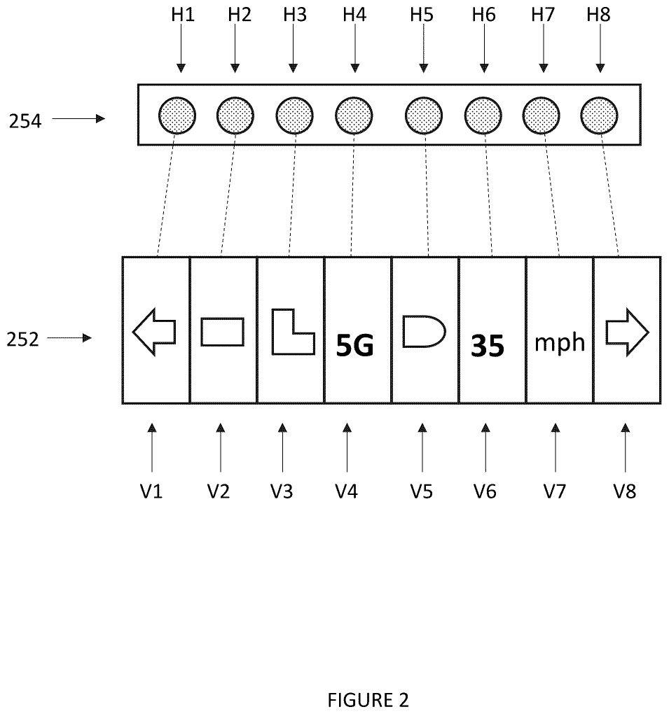

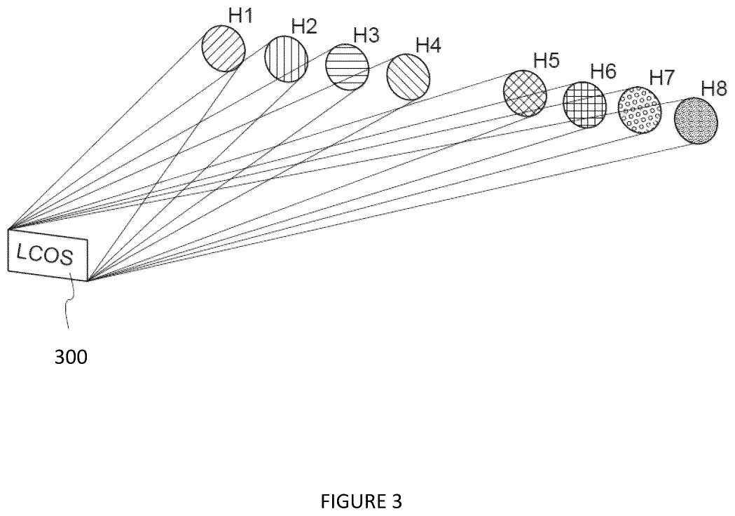

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram, shown as LCOS 300 in this example, directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

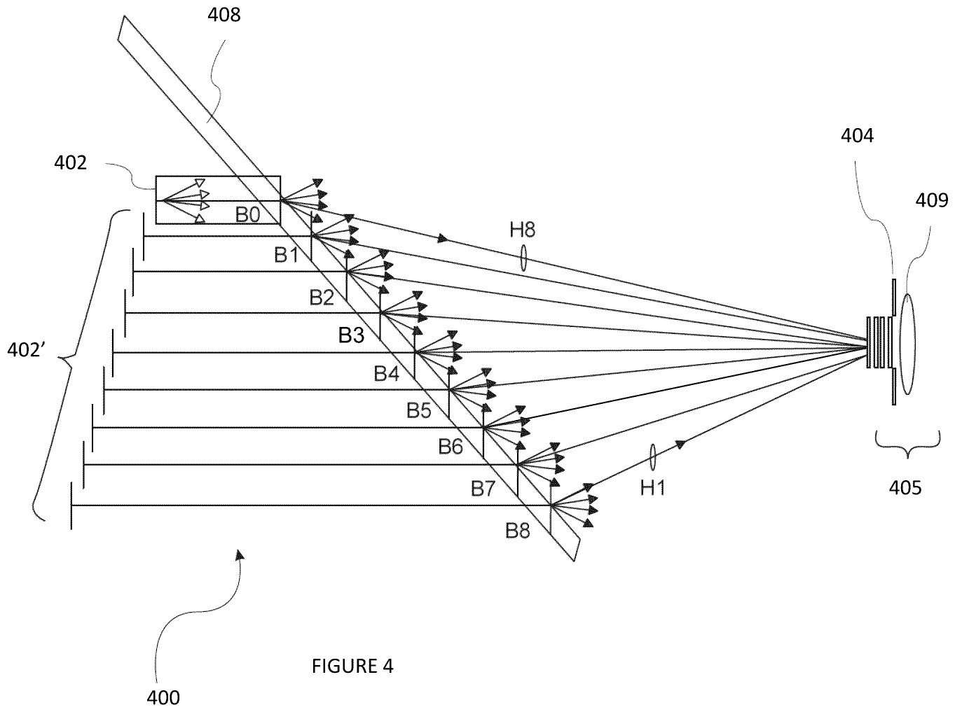

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

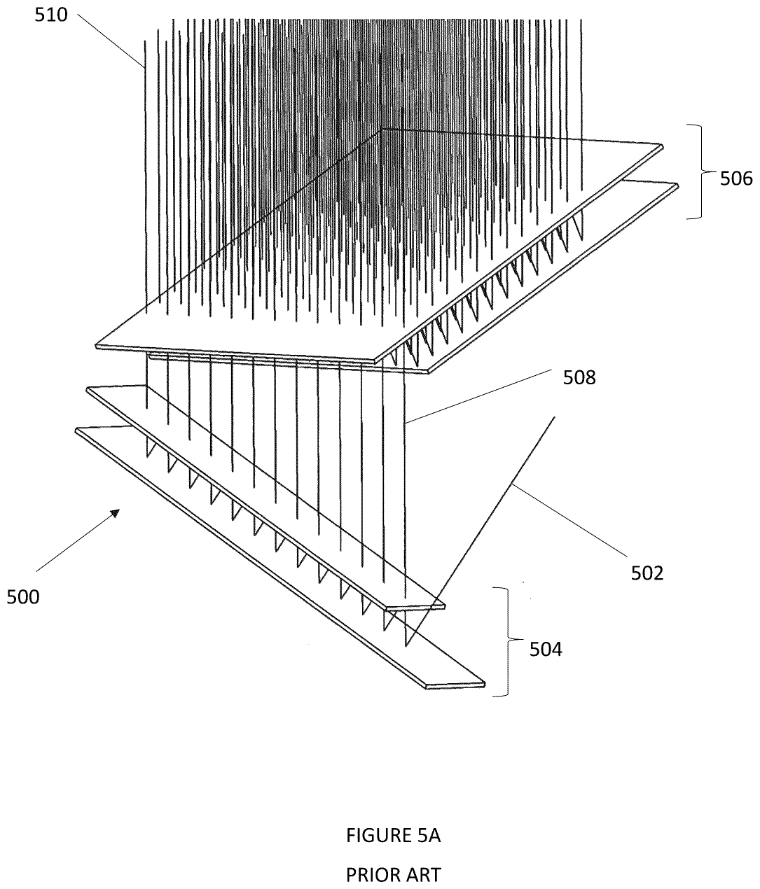

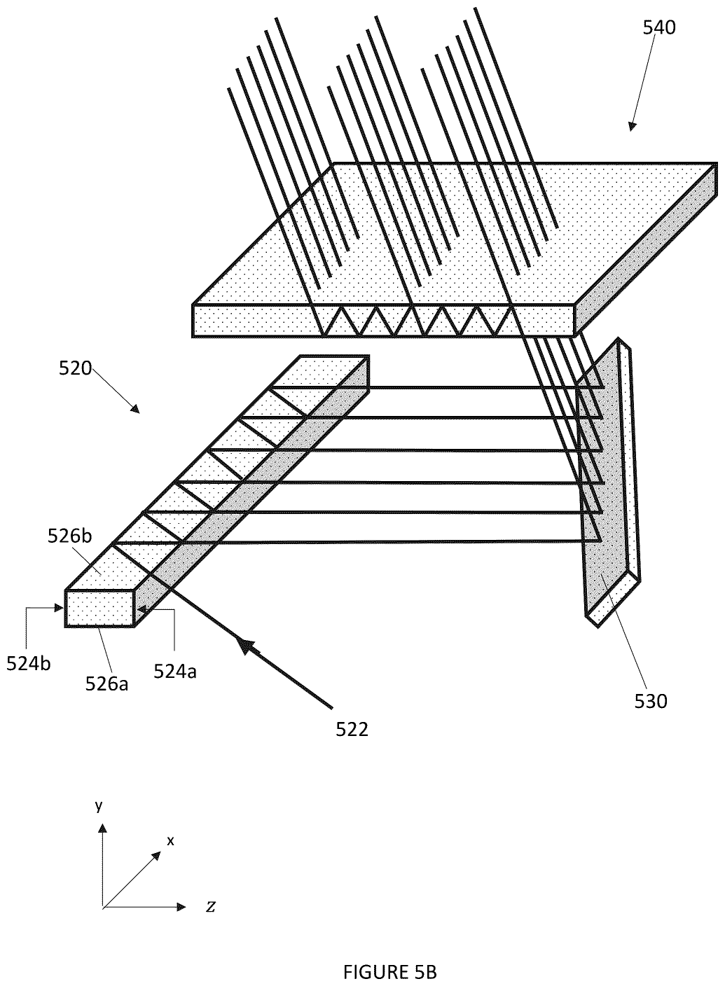

The waveguide 408 forms a plurality of replicas of the hologram, at the respective “bounce” points 1 to B8 along its length, corresponding to the direction of pupil expansion. As shown in FIG. 5, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504.

Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540. Replicator 520 has elongate parallel reflective surfaces 524a and 524b, as well as two other surfaces 526a and 526b.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 (published as GB2607899A) and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the deliver of hologram light channels, and their replicas, to the eye-box. Each aperture or window may comprise a plurality of liquid crystal cells or pixels.

Multi-Channel Muxing within a Waveguide

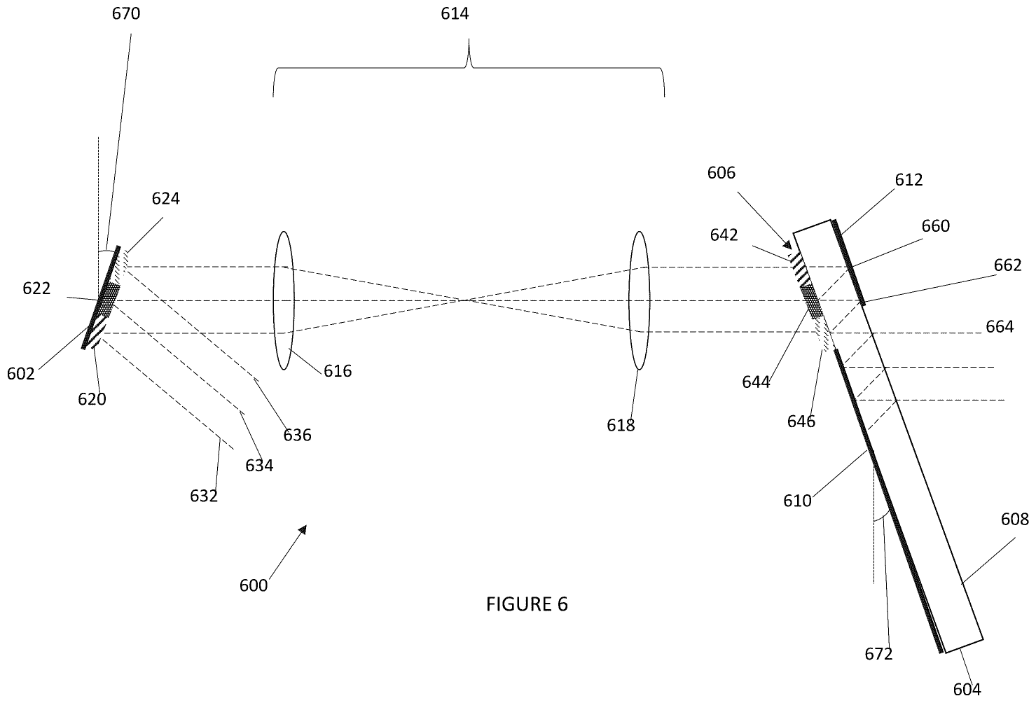

FIG. 6 shows a cross-sectional view of components of a holographic projection system 600. The holographic projection system 600 comprises a display device 602. In this example, the display device 602 is a liquid crystal on silicon spatial light modulator (LCOS SLM). The holographic projection system 600 further comprises a waveguide 604. The waveguide comprises an input port 606 for receiving light to be waveguided between a pair of opposing surfaces of the waveguide 604. The pair of surfaces of the waveguide comprises a first surface 608 which is partially transmissive-partially reflective and a second surface 610 which is substantially reflective. The first surface 608 being partially transmissive-partially reflective means that replicas of the light being waveguided are emitted when said light is incident/(partially) reflected off the first surface 608. The first surface 608 comprises a reflective coating 612 on a portion of the first surface 608 optically opposing the input port 606. Thus, light, received in the waveguide via the input port, is totally internally reflected when incident on the portion of the first surface 608 comprising the coating 612. No replicas are emitted from this portion. This will explained in more detail below.

The holographic projection system 600 further comprises an optical relay 614 comprising a first lens 616 and a second lens 618. The display device 602 is positioned substantially at a front focal plane of the first lens 616. A back focal plane of the first lens 616 is substantially co-planar with a front focal plane of the first lens 618. The input port 606 of the waveguide 604 is positioned substantially at the back focal plane of the second lens 618. The optical relay 614 may be described as a telescope, with the display device 602 (and what is displayed on the display device) being the object. An image of the object is formed at the input port of the waveguide. Although the optical relay 614 may be described as a telescope, in this example, the optical power of the first and second lenses is equal (such that the focal length of the first and second lenses are also equal). In other words, the telescope in this example does not magnify (or demagnify) the image relative to the object. However, in other examples, the telescope may have a magnifying (or demagnifying) effect.

In this example, the display device 602 is arranged to display three holograms (comprising a first hologram 620 of a first picture, a second hologram 622 of a second picture, and a third hologram 624 of a third picture). In this example, the three holograms are displayed adjacent, but not overlapping, one another (such that each hologram is abutting another hologram). In this example, the three holograms are displayed simultaneously. The display device 602 may be described as comprising three adjacent display areas or portions. Each hologram is displayed in a respective display area or portion. The holographic projection system 600 further comprises three light sources. The light sources themselves are not shown in the drawings, but the light that is emitted by the light sources is represented by dashed lines. Each dashed line represents a propagation/propagation axis of the emitted light through the holographic projection system. A first light source is arranged to emit a first light beam 632 having a first wavelength. A second light source is arranged to emit a second light beam 634 having a second wavelength. A third light source is arranged to emit a third light beam 636 having a third wavelength. In this example, the first wavelength is a wavelength corresponding to visible red light, the second wavelength is a wavelength corresponding to visible blue light, and the third wavelength is a wavelength corresponding to visible green light. The first light source/light beam 632 is arranged to illuminate the first hologram 620 displayed on a first display area of the display device 602. The second light source/light beam 634 is arranged to illuminate the second hologram 622 displayed on a second display area of the display device. The third light source/light beam 636 is arranged to illuminate the third hologram 624 displayed on a third display area of the display device. In this example, each light source is arranged to emit coherent light. In this example, each light source is a laser.

The display device 602 is arranged such that light incident on the respective display area is spatially modulated in accordance the hologram displayed on that display area to form a holographic wavefront. Thus, light of the first light beam 632 is spatially modulated in accordance with the first hologram 620 to form a first holographic wavefront; light of the second light beam 634 is spatially modulated in accordance with the second hologram 622 to form a second holographic wavefront; and light of the third light beam 636 is spatially modulated in accordance with the third hologram 624 to form a third holographic wavefront. As shown by the three dashed lines in FIG. 6, the first to third holographic wavefronts/light beams 632 to 636 are received by the first lens 616, and then relayed to the second lens 618. As above, the second lens 618 forms an image at the back focal plane such that each of the first to third holograms are imaged at the back focal plane of the second lens 618. The images of the first to third holograms may be referred to as relayed first to third holograms 642, 644, 646. Corresponding shading is used in FIG. 6 for the hologram and respective relayed hologram. This shading shows that the order of the first to third relayed holograms is flipped relative to the holograms displayed on the display device 602. This is because of optical relay 614.

The input port 606 comprises three input areas, a first input area for receiving the first relayed hologram; a second input area for receiving the second relayed hologram; and a third input area for receiving the third relayed hologram. The first input area comprises a coating forming first bandpass filter arranged to allow for the transmission of light of the first wavelength. The second input area comprises a coating forming a second bandpass filter arranged to allow for the transmission of light of the second wavelength. The third input are comprises a coating forming a third bandpass filter arranged allow for the transmission of light of the third wavelength. The coating of the second input area is substantially reflective to light of the first wavelength. The coating of the third input area is substantially reflective to light of the third wavelength. Thus, each of the coatings allow for efficient transmission of the respective hologram into the waveguide, but also achieve muxing of the three holographic wavefronts in the waveguide 602.

In more detail, the first holographic wavefront is transmitted into the waveguide 604 through the first input area. The first holographic wavefront is then reflected by the reflective coating 612 at position 660. This is a first internal reflection in the waveguide 604 of the first holographic wavefront. The first holographic wavefront is then relayed to the reverse surface of the second input area whereby the first holographic wavefront is reflected by the coating on the second input area. Simultaneously, the second holographic wavefront is transmitted by the second input area. Thus, after interaction with the second input area, the first and second holographic wavefronts have been combined or muxed. The muxed first and second holographic wavefronts propagate to the reflective coating 612 to be reflected by reflective coating 612 at position 662. This is the third internal reflection of the first holographic wavefront and the first internal reflection of second holographic wavefront. The first and second holographic wavefront are then relayed to the reverse surface of the third input area whereby the first and second holographic wavefronts are reflected (for a fourth and second time, respectively). Simultaneously, the third holographic wavefront is transmitted by the third input area. Thus, after the interaction with the third input area, the first, second and third holographic wavefronts have been combined or muxed. A combined (multi-colour) holographic wavefront (comprising the first to third holographic wavefronts) continues to be waveguided by the waveguide 604. Each time the combined holographic wavefront is reflected by the first surface of the waveguide 604, a replica 664 of the combined holographic wavefront is emitted.

The combined holographic wavefront 664 may be receivable at an eye-box of holographic projection system to form a multi (or full) colour virtual image. In this example, the first to third pictures of the first to third holograms are single colour version of the picture of the virtual image. By muxing the three different single colours, the full colour virtual image can be formed from the three single colours. Muxing the three colour channels in the waveguide is compact and optically efficient and does not require dedicated optical components to achieve the muxing.

### Co-Planar Hologram(s) and Input Port

Holographic projection systems according to the present disclosure are arranged such that the relayed hologram(s) are positioned in the same plane as a plane of the input port. In other words, the relayed hologram(s) are co-planar with the input port.

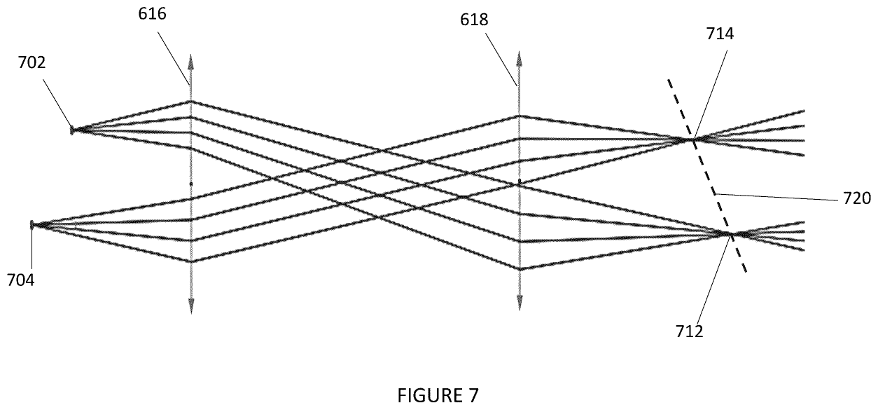

For example, in the holographic projection system 600 shown in FIG. 6, the relayed first to third holograms 642, 644, 646 are each co-planar with the input port 606. In particular, each of the relayed first to third holograms 642, 644, 646 are co-planar with the respective input area of the input port 606 (and each of the input areas of the input are co-planar with one another). The advantage of this co-planar arrangement is that the relayed holograms 642, 644, 646 are each in exact focus at the input port (and are in focus along the length and width of each of relayed hologram). This enable the relayed holograms to be precisely aligned with the respective input are of the input port 606, without overlap or other mixing of the holographic wavefronts at the input port 606. This allows for the muxing (described above) to be achieved efficiently, without the introduction of artefacts or cropping of any or each of the individual holographic wavefronts. This concept is explained in more detail in relation to FIG. 7.

FIG. 7 shows a ray-diagram showing light propagating from first and second points 702, 704 on the display device 602. The first and second points 702, 704 are spatially separated. Because the display device 602 is angled (see angle 670 in FIG. 6), the first point 702 appears forward of the second point 702. FIG. 7 shows how rays of light emitted from the first and second points 702, 704 are diverging. FIG. 7 further shows how the rays of light are converged by the optical relay 608 such that a first image point 712 is formed from first point 702 and a second image point 714 is formed of second point 704. The ray diagram of FIG. 7 shows how the first and second image points 712, 714 are only in focus at single point in space. Up and downstream of each point, the light rays diverge such that light associated with adjacent points will mix and overlap. It may not be possible to separate light associated with different points other than at the focus point. For example, it may not be possible to align the edge of a hologram with an edge of a reflective coating without acting on light of an adjacent hologram other than when the holograms are in focus. Because the first point 702 is forward of the second point 704, the first image point 712 is also forward of the second image point 714. A dotted line 720 has been drawn on FIG. 7 through the two points of focus. All image points of the relayed hologram will be formed along this dotted line 720. Thus, the inventors have recognised that, for the holograms of FIG. 6 to be in perfect focus when received by the input port, the input port 606 should be aligned with the line 720. In other words, the input port 606 and the hologram should be co-planar. In this example, this achieved because a second angle 672 of the waveguide 602 is equal to the first angle 670. This is true because the optical relay 608 does not magnify or demagnify the images of the holograms.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A holographic projection system comprising:
a display arrangement comprising a display area arranged to display a first hologram of a first picture and to spatially modulate light incident thereon in accordance with the first hologram to form a holographic wavefront;
an optical system arranged to receive the holographic wavefront and form a relayed image of the first hologram; and
a waveguide comprising an input port arranged to receive the holographic wavefront and a pair of surfaces arranged to waveguide the holographic wavefront therebetween;
wherein a plane of the display area is angled such that the relayed image of the first hologram is formed at a first plane, the first plane being parallel with a plane of the input port,
wherein a tilt of the display area opposes that of the relayed image of the hologram.

2. The holographic projection system according to claim 1, wherein the first plane is co-planar with the plane of the input port.

3. The holographic projection system according to claim 1, wherein the holographic projection system is arranged such that the wavefront propagates along a propagation axis, wherein a first angle is defined between a normal of the display area and a first portion of the propagation axis and a second angle is defined between a normal of the plane of the input port and a second portion of the propagation axis.

4. The holographic projection system according to claim 3, wherein the optical system has a unity magnification such that the first angle is substantially equal to the second angle.

5. The holographic projection system according to claim 3, wherein the optical system has non-unity magnification such that the first angle is not equal to the second angle.

6. The holographic projection system according to claim 1, wherein the optical system is an optical relay comprising a pair of lenses between the display device and the input port, the optical relay being arranged to form the relayed image of the first hologram.

7. The holographic projection system according to claim 1, wherein a first surface of the pair of surfaces of the waveguide is arranged to provide a plurality, n, of light emission zones for emitting a corresponding plurality of replicas of the holographic wavefront.

8. The holographic projection system according to claim 7,
wherein a separation of the pair of surface of the waveguide is arranged such that at least a portion of each of the light emission zones overlaps with an adjacent emission zone.

9. The holographic projection system according to claim 1, wherein a waveguiding direction of the waveguide is perpendicular to a normal of first plane.

10. The holographic projection system according to claim 1, wherein the holographic projection system further comprises a second hologram of a second picture, wherein the optical system is arranged to form a relayed second hologram which is also positioned at the first plane.

11. The holographic projection system according to claim 10, wherein the relayed first hologram is adjacent to the relayed second hologram.

12. The holographic projection system according to claim 10, wherein the input port comprises a first input area arranged to receive the first relayed hologram and a second input area arranged to receive the second relayed hologram.

13. The holographic projection system according to claim 12, wherein the waveguide is arranged to waveguide the holographic wavefront in a first direction of waveguiding, and wherein a width of the first input area in the first direction is substantially equal to the width of the second input area in the direction of waveguiding.

14. A method of holographic projection, the method comprising:
spatially modulating light in accordance with a first hologram to form a holographic wavefront;
receiving the holographic wavefront at an optical system so as to form a relayed image of the first hologram; and then
receiving the holographic wavefront at the input port of a waveguide, wherein the waveguide comprises a pair of surface such that the received holographic wavefront is waveguided therebetween;
wherein the first hologram is positioned at a first plane, the first plane being co-planar with a plane of the input port, and
wherein a plane of the display area is non-parallel with a plane of the first plane.
